(19) United States
(12) Patent Application Publication
(10) Pub. No.: US 2009/0229958 A1
(43) Pub. Date: Sep. 17, 2009

(54) Push-button switch

(75) Inventors: Hirofumi Koizumi, Osaka (JP); Satoshi Yamanaka, Osaka (JP)

Correspondence Address: BACON & THOMAS, PLLC, 625 SLATERS LANE, FOURTH FLOOR, ALEXANDRIA, VA, 22314-1176, US

(73) Assignee: Hosiden Corporation, Osaka (JP)

(21) Appl. No.: 12/382,150

(22) Filed: Mar. 10, 2009

(30) Foreign Application Priority Data
Mar. 11, 2008 (JP) 2008-061072

(51) Int. Cl. H01H 3/20

(52) U.S. Cl. 200/327

(57) ABSTRACT

The invention provides a push-button switch including: a star wheel (15) which is rotated by a constant angular step in one direction by a depression of a push button (4) that automatically returns; an indenter (7) which is pressed against the outer periphery of the star wheel (15) by a spring (8); a contact (9) which is attached so as to corotate with the star wheel (15), and which serves as a movable contact; and terminals (10, 11, 12) with which the contact (9) is contacted in accordance with a rotation angle, and which serve as stationary contacts. A small projection (16) having a rounded tip end is disposed in each of ridge portions (15a) of the star wheel (15). Even when the slope of each ridge portion (15a) does not have a large inclination angle, the star wheel (15) is prevented from being stopped at a position where the ridge portion (15a) is opposed to the indenter (7).

### BACKGROUND OF THE INVENTION

1. Field of the Invention

The present invention relates to a push-button switch in which a movable contact is rotated by a constant angular step in one direction by a depression of a push button, and contacted with stationary contacts in accordance with the rotation angle of the movable contact, thereby performing contact switching.

2. Description of the Prior Art

A positioning mechanism is incorporated into a push-button switch of this type. The positioning mechanism includes: a star wheel which is rotated by a constant angular step in one direction through a ratchet mechanism or the like which is operated by a depression of a push button that automatically returns; and an indenter which is configured by a metal ball or the like, and which is pressed against the outer periphery of the star wheel by a spring. A movable contact is attached so as to corotate with the star wheel (see Patent Reference 1).

The star wheel is hardly stopped at a position where a ridge portion is opposed to the indenter, and rotated to a position where a valley portion is opposed to the indenter to cause the indenter to fit in the valley portion, whereby the star wheel is stopped to hold the position of the movable contact in a return state of the push button (see Patent Reference 1).

In a push-button switch of this type, the indenter is caused to be contacted with the outer periphery of the star wheel which has alternately ridge and valley portions, thereby producing a sense of operation. In this case, it is important to prevent a switch operating force required for pushing the push button, from being increased.

Therefore, a star wheel in which ridge and valley portions having a relatively small inclination angle are alternately formed on the outer periphery is used (see Patent Reference 1).

In such a star wheel, however, slopes of the ridge portions have a small inclination angle. When a load of the indenter is applied to the apex of one of the ridge portions, therefore, a balance is easily established, thereby producing a problem in that the star wheel is easily stopped at a position where the ridge portion is opposed to the indenter.

As a conventional technique for solving the problem, a configuration has been proposed where an inflection point is disposed in a middle of a slope of a ridge portion, and the inclination angle of a slope portion extending from the inflection point to the apex of the ridge portion is set so as to be larger than that of another slope portion extending from the inflection point to the valley portion, whereby the indenter is prevented from being stopped at the ridge portion (see Patent Reference 2).

[Patent Reference 1] Japanese Utility Model Application Laying-Open No. 60-15722

[Patent Reference 2] Japanese Utility Model Application Laying-Open No. 5-97028

### SUMMARY OF THE INVENTION

In the conventional technique, the slope in the vicinity of the apex of the ridge portion has the large inclination angle, and abrasion easily occurs in the apex of the ridge portion. Therefore, there is a problem in that, as the number of operations of pressing the push button is more increased, the effect is further lessened, and finally disappears.

In order to solve the above-discussed problems, the invention is configured so that a push-button switch includes: a star wheel which is rotated by a constant angular step in one direction by a depression of a push button that automatically returns; an indenter which is pressed against the outer periphery of the star wheel by a spring; a contact which is attached so as to corotate with the star wheel, and which serves as a movable contact; and terminals with which the contact is contacted in accordance with a rotation angle, and which serve as stationary contacts, and a small projection having a rounded tip end is disposed in each of ridge portions of the star wheel.

According to the invention which has the above-described configuration, when a load of the indenter is applied to the apex of one of the ridge portions, the small projection causes a balance to be hardly established. Even when the slope of each ridge portion does not have a large inclination angle, therefore, the star wheel can be prevented from being stopped at a position where the ridge portion is opposed to the indenter. The effect is exerted while, as the number of operations of pressing the push button is more increased, the effect is not further lessened to finally disappear.

Furthermore, the tip end of the small projection is rounded, and hence the small projection shows excellent abrasion resistance, so that it is possible to surely prevent the phenomenon that, as the number of operations of pressing the push button is more increased, the above-discussed effect is further lessened, and finally disappears, from occurring.

The above effects can be achieved by the small projection which is very smaller than the ridge and valley portions and indenter of the star wheel. Therefore, a force required for the small projection to override the indenter is negligibly small as compared to that required for the ridge portion to override the indenter. The contact switching can be performed by a switch operating force which is equivalent to that in the prior art, and the small projection does not affect the operational sense, so that an operational sense which is equivalent to that in the prior art is obtained.

### BRIEF DESCRIPTION OF THE DRAWINGS

FIG. 1 is a perspective view of a rotor (star wheel) of a push-button switch of an embodiment of the invention.

FIG. 2 is a perspective view of the push-button switch of the embodiment of the invention.

FIG. 3 is an exploded view of the push-button switch of the embodiment of the invention.

FIG. 4 is a longitudinal section view of a push button portion of the push-button switch of the embodiment of the invention.

FIG. 5 is a longitudinal section view of a driving mechanism portion and positioning mechanism portion of the push-button switch of the embodiment of the invention.

FIG. 6A is a plan view of a case of the push-button switch of the embodiment of the invention, and FIG. 6B is a side view of the case.

FIG. 7A is a side view of a terminal base of the push-button switch of the embodiment of the invention, and FIG. 7B is a rear (inner face) view of the terminal base.

FIG. 8A is a side view of a push button of the push-button switch of the embodiment of the invention, and FIG. 8B is a side view of the push button.

FIG. 9A is a front view of a contact of the push-button switch of the embodiment of the invention, and FIG. 9B is a bottom view of the contact.

FIG. 10A is a front view of a contact portion of the push-button switch of the embodiment of the invention, and FIG. 10B is a front view of the contact portion after switching.

FIG. 11A is a partial enlarged front view of the positioning mechanism portion of the push-button switch of the embodiment of the invention, and FIG. 11B is a partial enlarged front view of the positioning mechanism portion in the course of operation.

### DESCRIPTION OF REFERENCE NUMERALS

4 push button
7 indenter
8 indenter spring
9h movable contact
10a common contact (stationary contact)
11a, 11b first selection contact (stationary contact)
12a, 12b second selection contact (stationary contact)
15 positioning star wheel
15a ridge portion
16 small projection

### DETAILED DESCRIPTION OF THE PREFERRED EMBODIMENT

Hereinafter, an embodiment of the invention will be described with reference to the accompanying drawings.

In the embodiment, a push-button switch in which two kinds of switch circuits are opened/closed by a depression of a push button is shown. For example, the push-button switch is used in an application where the turn on/off of a vehicle interior lamp is switched. When the push button is depressed in the state where the lamp is turned off, a turn-off circuit is opened, and a turn-on circuit is closed. When the push button is depressed in the state where the lamp is turned on, the turn-on circuit is opened, and the turn-off circuit is closed.

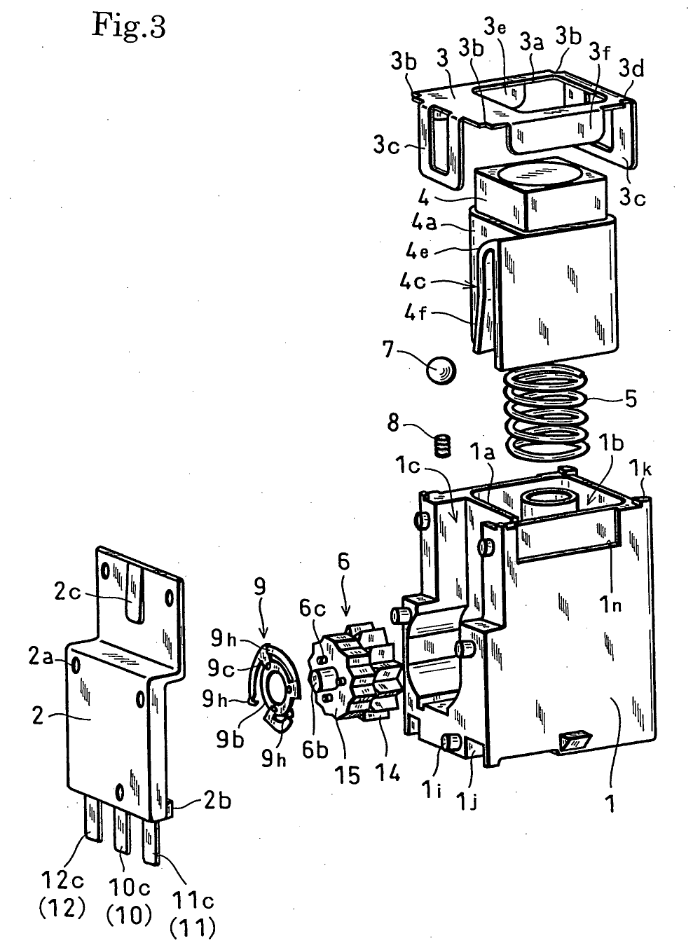

As shown in FIG. 3, the push-button switch is configured by: a case 1 which is made of a synthetic resin, and which is insulative; a terminal base 2 which is made of a synthetic resin, and which is insulative; a cover 3 which is formed by stamping and bending a metal plate; the push button 4 which is made of a synthetic resin, and which is insulative; a push-button return spring 5 which is configured by a metal coil spring; a rotor 6 which is made of a synthetic resin, and which is insulative; an indenter 7 which is configured by a metal ball (or a roller); an indenter spring 8 which is configured by a metal coil spring; and a contact 9 which is formed by stamping and bending a highly conductive thin metal plate.

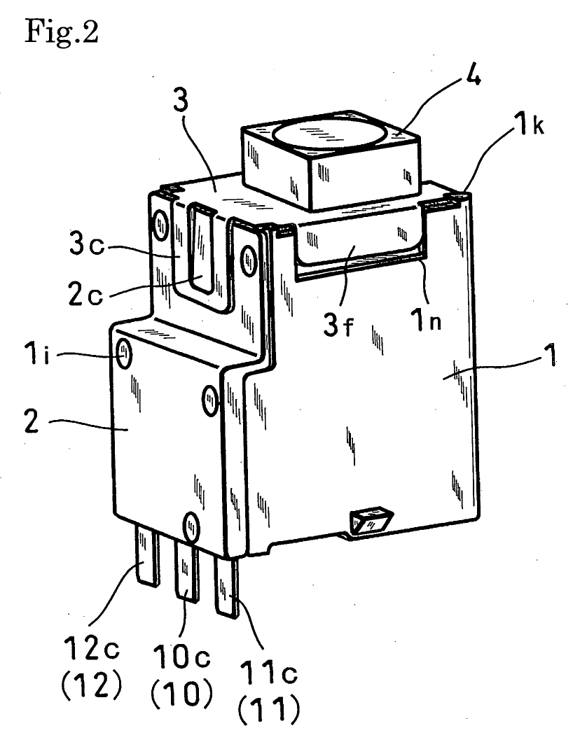

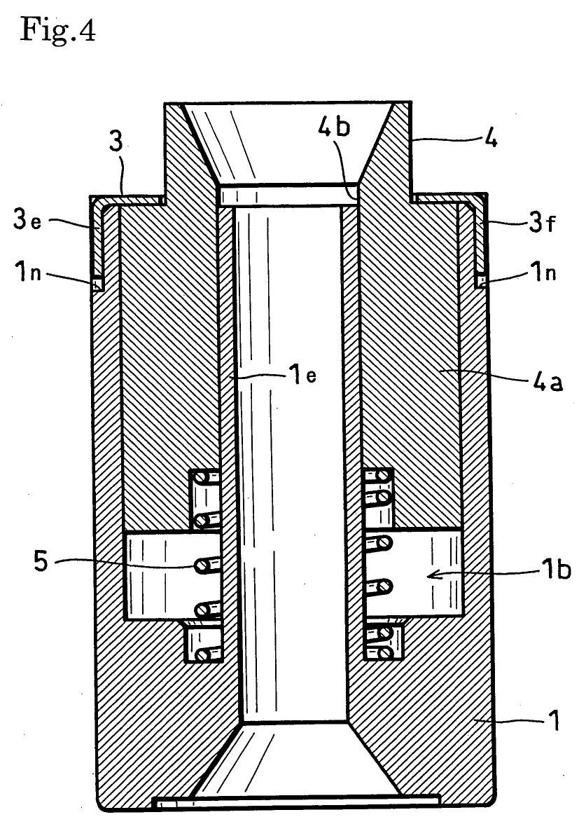

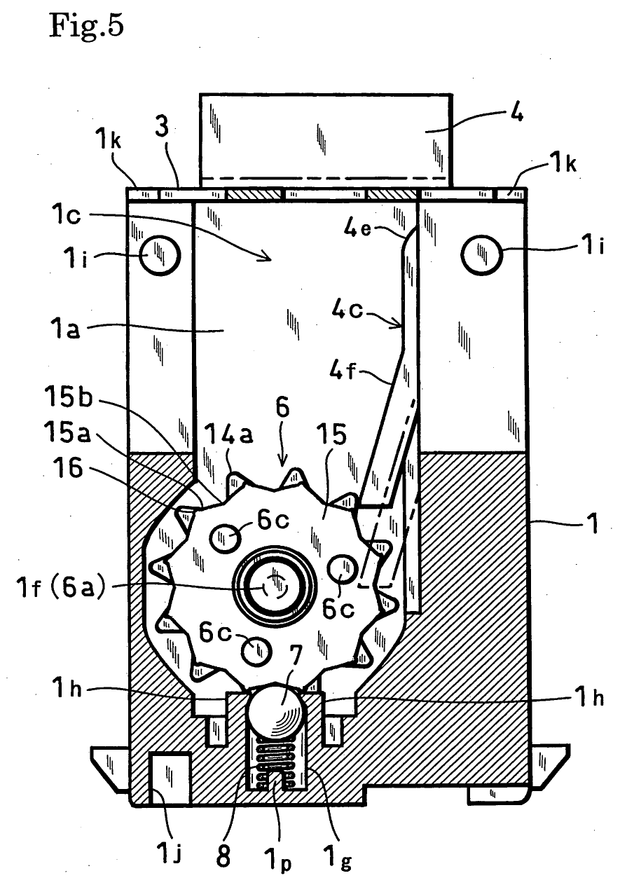

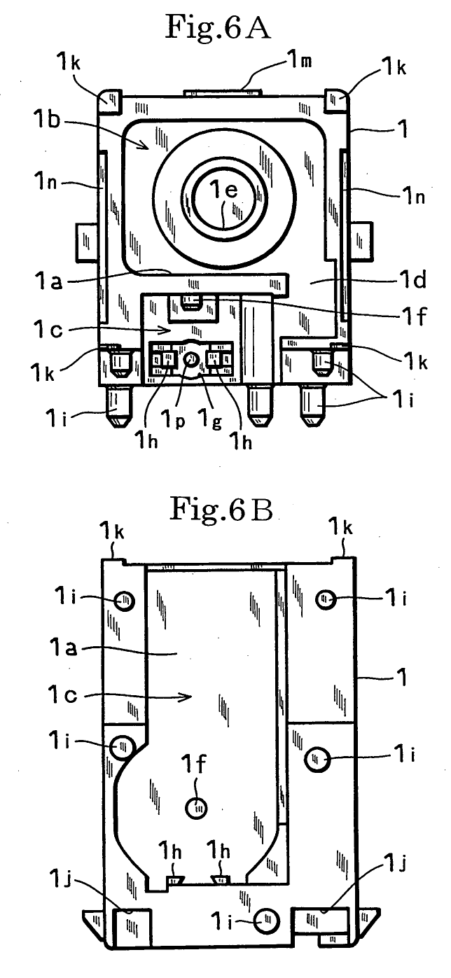

As shown in FIGS. 2 to 5, 6A, and 6B, the case 1 is formed into a box-like shape in which one side face and the upper face are opened. Hereafter, the description will be made while assuming that the opened one side face of the case 1 is the front side face of the push-button switch.

Inside the case 1, a partition wall 1a which is protruded in parallel to the rear side wall from a front portion of the inner face of the left side wall, and which does not reach a front portion of the inner face of the right side wall is disposed. The interior space of the case 1 is partitioned by the partition wall 1a into a push-button housing space 1b in which the upper face is opened, and a rotor housing space 1c in which the upper face and the front side face are opened. The two spaces 1b, 1c communicate with each other through a gap 1d between a right end portion of the partition wall 1a and a front portion of the inner face of the right side wall.

A cylindrical push-button guide 1e is vertically raised from the bottom face in a center portion of the push-button housing space 1b. A rotor shaft 1f having a longitudinal axis is protruded from the partition wall 1a in a lower portion of the rotor housing space 1c. An intender housing recess 1g is disposed in the bottom side of the rotor housing space 1c. A pair of right and left intender pressing nails 1h are raised from the right and left sides of the recess, respectively. In a center portion of the intender housing recess 1g, an indenter spring rod 1p is vertically raised from the bottom face. The axes of the intender housing recess 1g and the indenter spring rod 1p are in a vertical plane including the axis of the rotor shaft 1f.

Outside of the case 1, disposed are a plurality of base fixing pins 1i which are forward protruded from an opening edge portion of the front side face of the case 1, base fitting recesses 1j which are formed in lower right and left corners of the opening edge portion of the front side face of the case 1, cover positioning projections lk which are upward protruded from the four corners of an opening edge portion of the upper face of the case 1, a cover engaging hook 1m which is rearward protruded from an upper portion of the outer face of the rear side wall of the case 1, and shallow cover fitting recesses 1n which are formed in upper portions of the outer faces of the right and left side walls of the case 1.

In the terminal base 2, as shown in FIGS. 2, 3, 7A, and 7B, a plurality of different terminals (in the embodiment, three terminals of three kinds, or a common terminal 10, a first selection terminal 11, and a second selection terminal 12) which are formed by stamping and bending a highly conductive thin metal plate are integrated with one another by insert molding. The terminal base is formed into a lid-like shape which covers the opened front side face of the case 1.

In the terminal base 2, a plurality of pin holes 2a which are passed between the inner and outer faces formed on an outer side portions of the terminal base 2, fitting projections 2b which are protruded from right and left corners of a lower portion of the inner face of the terminal base 2, and a cover engaging hook 2c which is protruded from an upper portion of the outer face of the terminal base 2.

A circular contact housing recess 2d which, when the terminal base 2 is attached to the opened front side face of the case 1, is concentric with the rotor shaft 1f is disposed in the inner face of the terminal base 2. A bearing recess 2e is disposed in a center portion of the contact housing recess.

A common contact 10a, two first selection contacts 11a, 11b, and two second selection contacts 12a, 12b which serve as stationary contacts are disposed at intervals in plural places on the same circumference in an outer peripheral portion of the bottom face of the contact housing recess 2d, respectively.

The common contact 10a is formed by, in a substantially flush manner, exposing one end portion of the common terminal 10 among the terminals embedded in the terminal base 2 in one place which is in an outer peripheral portion of the bottom face of the contact housing recess 2d, and which is different from the places of the other stationary contacts, and therefore is a stationary contact which is conductive with the common terminal 10.

The two first selection contacts 11a, 11b are formed by splitting one end portion of the first selection terminal 11 among the terminals embedded in the terminal base 2 into two pieces, and, in a substantially flush manner, exposing the two pieces in two places which are in the outer peripheral portion of the bottom face of the contact housing recess 2d, and which are different from the places of the other stationary contacts, and therefore are stationary contacts which are conductive with the first selection terminal 11.

The two second selection contacts 12a, 12b are formed by splitting one end portion of the second selection terminal 12 among the terminals embedded in the terminal base 2 into two pieces, and, in a substantially flush manner, exposing the two pieces in two places which are in the outer peripheral portion of the bottom face of the contact housing recess 2d, and which are different from the places of the other stationary contacts, and therefore are stationary contacts which are conductive with the second selection terminal 12.

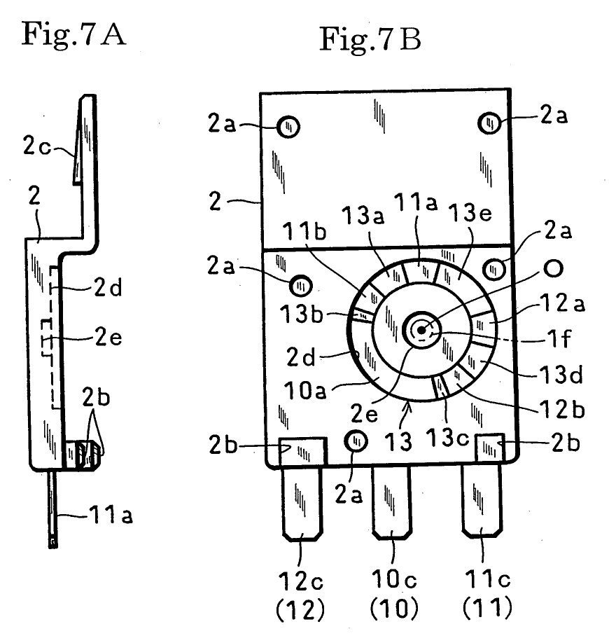

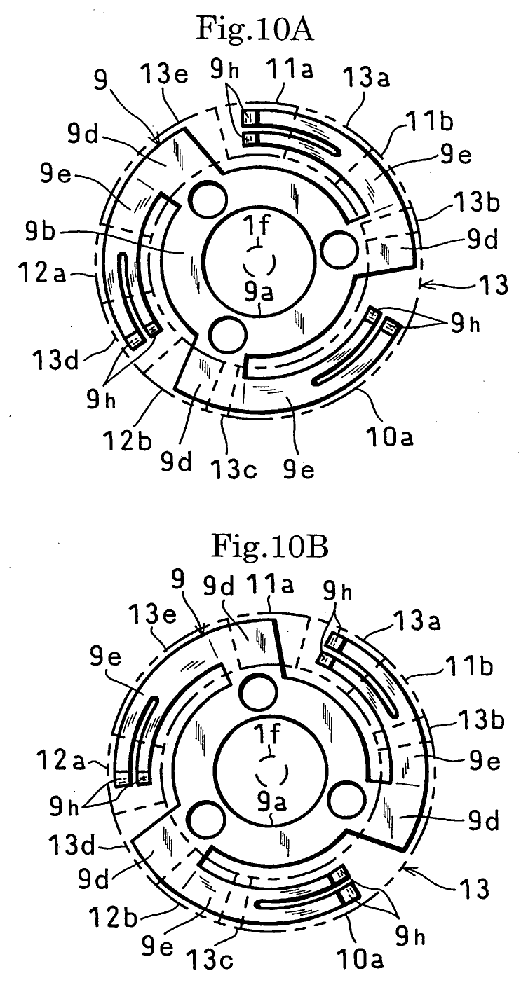

Referring to FIG. 7B (FIGS. 10A and 10B), in a counterclockwise direction (clockwise direction) with starting from a stationary contact disposed in one place of the outer peripheral portion of the bottom face of the contact housing recess 2d, for example, the one first selection contact 11a having an arcuate shape of a central angle of 30 deg., a first insulation contact 13a which is formed by an arcuate resin surface of a central angle of 30 deg., the other first selection contact 11a having an arcuate shape of a central angle of 25 deg., a second insulation contact 13b which is formed by an arcuate resin surface of a central angle of 7.5 deg., the arcuate common contact 10a of a central angle of 115 deg., a third insulation contact 13c which is formed by an arcuate resin surface of a central angle of 7.5 deg., the arcuate other second selection contact 12b of a central angle of 25 deg., a fourth insulation contact 13d which is formed by an arcuate resin surface of a central angle of 30 deg., the arcuate one second selection contact 12a of a central angle of 30 deg., and a fifth insulation contact 13e which is formed by an arcuate resin surface of a central angle of 60 deg. are disposed in this sequence, so that an annular movable-contact sliding face 13 is formed concentrically with the rotor shaft 1f.

The other end sides of the common terminal 10, the first selection terminal 11, and the second selection terminal 12 which are embedded in the terminal base 2 in an insulated state are protruded in one lateral row at intervals from the lower end face of the terminal base 2, and formed as external connecting terminal portions 10c, 11c, 12c of the push-button switch, respectively.

As shown in FIGS. 2 to 5, the cover 3 is formed into a lid-like shape which covers the opened upper face of the case 1.

In the cover 3, a push button hole 3a which is formed at a position of the cover 3 opposed to the push-button housing space 1b, which is slightly smaller than the upper face opening of the push-button housing space 1b, through which the push button 4 can be passed, and which is passed between the inner and outer faces, cutaway portions 3b which are formed in four corner portions of the cover 3, a pair of front and rear U-like leg portions 3c, 3d which are bent and downward elongated from the front and rear edges of the cover 3, respectively, and a pair of left and right leg portions 3e, 3f which are bent and downward elongated from the left and right edges of the cover 3, respectively are disposed.

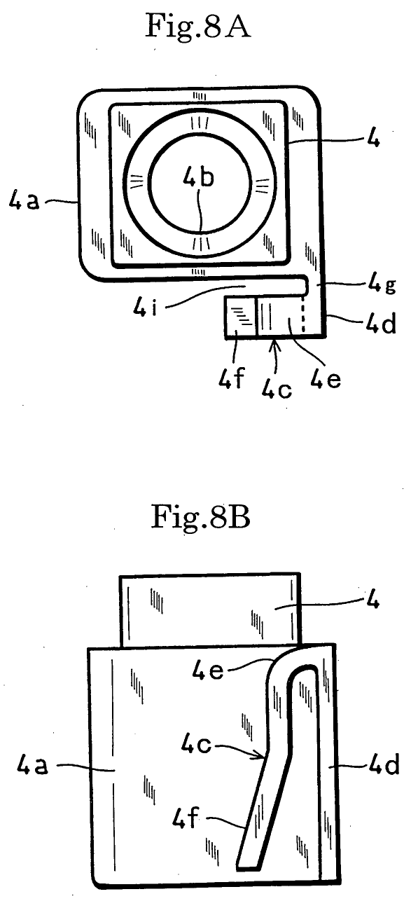

In the push button 4, as shown in FIGS. 3 to 5, 8A, and 8B, a sliding portion 4a which is formed under the push button 4, which is slightly larger than the push button 4, and which can be vertically slidably fitted into the push-button housing space 1b of the case 1, a center hole 4b which is passed between the upper face of the push button 4 and the lower face of the sliding portion 4a, and a feed lever 4c which is formed in the front side of the sliding portion 4a and shifted toward the right side, and which has a substantially inverted U-like shape as seen from the front side are integrally disposed.

In the feed lever 4c, a linear fixing piece portion 4d which is vertically elongated, a folded back portion 4e which is formed in an upper end portion of the fixing piece portion 4d, and which is substantially quarter arcuate, a pressing piece portion 4f which is downward elongated from the folded back portion 4e, and which is bent into an L-like shape so that the gap between the portion and the fixing piece portion 4d is gradually expanded in the range from the middle to the lower end, and a connecting portion 4g which extends from one side end face of the fixing piece portion 4d toward the sliding portion 4a, and which causes the fixing piece portion 4d to be formed wider than the folded back portion 4e and the pressing piece portion 4f are integrally disposed.

In the feed lever 4c, the fixing piece portion 4d is integrally coupled to a right end portion of the front side face of the sliding portion 4a via the connecting portion 4g, a gap 4i is disposed between the front side face of the sliding portion 4a, and the folded back portion 4e and the pressing piece portion 4f, and the pressing piece portion 4f can be elastically deformed in the lateral directions along the front side face of the sliding portion 4a.

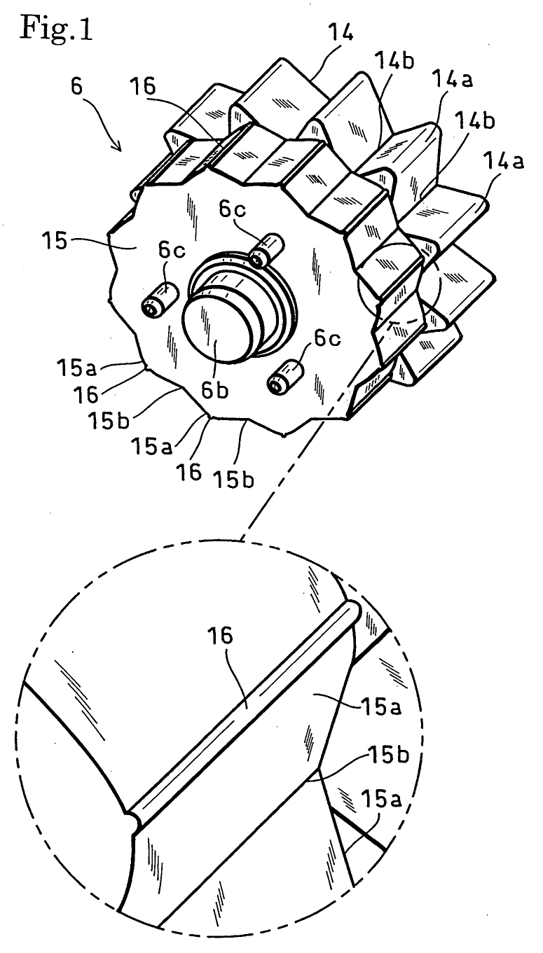

In the rotor 6, as shown in FIGS. 1, 3, and 5, a rotation star wheel 14 and a positioning star wheel 15 are integrally formed on the same axis.

In the rotor 6, a circular bearing recess 6a which is formed in a center portion of the side face on the side of the rotation star wheel 14, a rotor shaft 6b which is perpendicularly protruded from a center portion of the side face on the side of the positioning star wheel 15, and contact mounting pins 6c which are disposed on the side face on the side of the positioning star wheel 15, and which are perpendicularly protruded from three places that are at regular intervals on the same circumference concentric with the rotor shaft 6b are integrally disposed.

The rotation star wheel 14 has alternately ridge portions 14a and valley portions 14b on the outer periphery. The positioning star wheel 15 has alternately ridge portions 15a and valley portions 15b which are equal in number (twelve) to those of the rotation star wheel 14, on the outer periphery. In the star wheels 14, 15, the apexes of the ridge portions 14a, 15a are rounded.

In order to allow the lower end of the pressing piece portion 4f of the feed lever 4c of the push button 4 to be easily butted against the slopes of the ridge portions 14a of the rotation star wheel 14, the inclination angle of each of the slopes is set to an angle which is larger than 45 deg., for example, 60 deg. By contrast, the inclination angle of each of the slopes of the ridge portions 15a of the positioning star wheel 15 is set to an angle which is smaller than 45 deg., for example, 30 deg. so that the pressing force (switch operating force) required for depressing the push button 4 is not large, but not so excessively small that the push button 4 is accidentally depressed, and also so that a clear operational sense can be produced.

As shown in FIG. 1, a small projection 16 is disposed in the apex of each of the ridge portions 15a of the positioning star wheel 15.

Each small projection 16 has a substantially semicircular section shape. The tip end of the small projection 16 is rounded.

The external shape of the small projection 16 is formed into a streak shape which is parallel to the axis of the positioning star wheel 15. The small projection 16 is disposed on the apex of the corresponding ridge portion 15a over the whole width thereof.

As shown in FIGS. 3, 9A, 9B, 10A, and 10B, the contact 9 is formed into a disk-like shape.

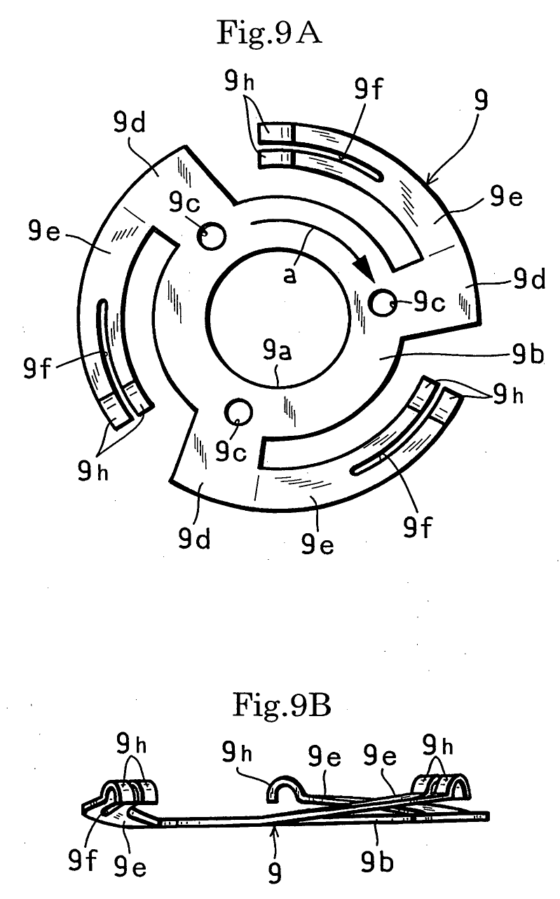

In the contact 9, a circular center hole 9a which is formed at the center of the contact, and which is passed between the inner and outer faces, a concentric annular connecting portion 9b which is formed in the periphery of the hole, mounting holes 9c which are formed at regular intervals in three places of the connecting portion 9b, and which are passed between the inner and outer faces, protruding pieces 9d which are radially protruded at regular intervals from three places of the connecting portion 9b, cantilever-like movable contact pieces 9e which arcuately extend from the protruding pieces 9d in regular spaces therebetween and in the peripheries of the connecting portion 9b while being separated by a constant gap therefrom, in a direction (counterclockwise direction) of the contact 9 that is opposite to the rotation direction (clockwise direction) indicated by the arrow a in FIG. 9A, slits 9f which bifurcate the movable contact pieces 9e, respectively, and semicircular movable contacts 9h which are formed at the tip ends of the respective movable contact pieces 9e so that the surface is convex and the rear face is concave are integrally formed.

In each of the movable contact pieces 9e, an inclination angle is formed so that the movable contact piece is gradually raised as advancing from the basal end toward the tip end. The movable contact piece 9e is elastically displaceable in the thickness direction of the contact 9.

The movable contact pieces 9e are formed into the same shape. The movable contacts 9h are disposed in the outer peripheral portion of the contact 9 and in three places that are at regular intervals on the same circumference concentric with the center hole 9a.

The outer peripheral edges of the protruding pieces 9d, and those of the movable contact pieces 9e are on the same circumference concentric with the center hole 9a, so that the external shape of the contact 9 is formed into a circular shape which is interrupted by the gaps between the tip ends of the movable contact pieces 9e and the protruding pieces 9d which are separated from the tip ends in a direction opposite to the rotation direction a of the contact 9.

The push-button switch is assembled in the following manner. The indenter spring 8 is dropped through the gap between the intender pressing nails 1h into the intender housing recess 1g of the case 1, and located outside the indenter spring rod 1p in the intender housing recess 1g. Then, the indenter 7 is pressingly installed through the gap between the intender pressing nails 1h into the intender housing recessing.

The indenter spring 8 is compressed between the indenter 7 and the bottom face of the intender housing recess 1g to always upward urge the indenter 7, and the intender pressing nails 1h press the indenter 7 from the upper side, thereby preventing the indenter from jumping out of the intender housing recess 1g. A part of the indenter 7 is protruded between the intender pressing nails 1h toward the bottom of the rotor housing space 1c. The center of the indenter 7 is located in a vertical plane including the axis of the rotor shaft 1f.

In a state where the rear face of the contact 9 is opposed to the side face of the rotor 6 on the side of the positioning star wheel 15, while the contact mounting pins 6c are fitted into the corresponding contact mounting holes 9c, the rotor shaft 6b is fitted into the corresponding center hole 9a, and the contact 9 is incorporated in a corotatable manner to the side face of the rotor 6 on the side of the positioning star wheel 15.

The rotor 6 to which the contact 9 is incorporated is incorporated to the case 1 to which the indenter spring 8 and the indenter 7 are incorporated. In a state where the opened front side face of the case 1 is opposed to the sidex face of the rotor 6 on the side of the rotation star wheel 14, while the rotor shaft if on the side of the case 1 is fitted into the bearing recess 6a on the side of the rotor 6, the rotor 6 to which the contact 9 is incorporated is incorporated to the lower portion of the rotor housing space 1c of the case 1.

The terminal base 2 is incorporated to the case 1 where the rotor 6 to which the contact 9 is incorporated is installed. In a state where the opened front side face of the case 1 is opposed to the inner face of the terminal base 2, while the base fixing pins 1i are fitted into the corresponding pin holes 2a, and the fitting projections 2b are fitted into the corresponding fitting recesses 1j, the rotor shaft 6b on the side of the rotor 6 is fitted into the bearing recess 2e on the side of the terminal base 2, and the terminal base 2 is incorporated to the opened front side face of the case 1.

The tip ends of the base fixing pins 1i which are protruded from the outer face of the terminal base 2 are fused and collapsed, so that the terminal base can be fixed by the opened front side face of the case 1.

The opened front side face of the case 1 is covered by the terminal base 2, and the opening of the front side face of the rotor housing space 1c is closed by the terminal base 2.

The both sides of the rotor 6 are rotatably supported by the coaxial rotor shafts 6b, 1f on the inner faces of the opposed front and rear sidewalls (the terminal base 2 and the partition wall 1a) of the rotor housing space 1c, respectively.

The contact 9 is sandwiched between the side face of the rotor 6 on the side of the positioning star wheel 15 and the bottom face of the contact housing recess 2d, and the surfaces of the movable contacts 9h are pressed against the movable-contact sliding face 13 by the elasticity of the movable contact pieces 9e. By the reaction force against the pressing, the contact 9 is rotatably fitted into the contact housing recess 2d in a state where the rear faces of the connecting portion 9b and the protruding pieces 9d are butted against the side face of the rotor 6 on the side of the positioning star wheel 15.

Furthermore, the push-button return spring 5 is incorporated outside the push-button guide 1e in the push-button housing space 1b of the case 1.

The push button 4 is incorporated to the case 1 to which the terminal base 2 and the push-button return spring 5 are incorporated, in the following manner. While the push-button guide 1e is fitted into the center hole 4b and the connecting portion 4g between the sliding portion 4a and the feed lever 4c is fitted into the gap 1d of the case 1, the sliding portion 4a is fitted into the push-button housing space 1b of the case 1, and the feed lever 4c is fitted into the rotor housing space 1c of the case 1, whereby the push button 4 is incorporated with being protruded to the upper side of the push-button housing space 1b of the case 1.

Finally, the cover 3 is incorporated to the case 1 to which the push button 4 is incorporated, in the following manner. While an upper portion of the case 1 is fitted into the inside of the front, rear, right, and left leg portions 3c, 3d, 3e, 3f, and the push button 4 is fitted into the push button hole 3a, the cover positioning projections 1k are fitted into the corresponding cutaway portions 3b to incorporate the cover 3 to the opened upper face of the case 1.

The cover 3 can be fixed to the opened upper face of the case 1 by fitting the right and left leg portions 3e, 3f into the corresponding cover fitting recesses In, and fitting the cover engaging hooks 1m, 2c into the inside of the front and rear leg portions 3c, 3d to be engaged therewith.

In the case 1, the opened upper face in the periphery of the push button 4 is covered by the cover 3, and the upper face opening of the rotor housing space 1c is closed by the cover 3.

The push-button return spring 5 is compressed between a spring seat of the lower face of the sliding portion 4a and that of the bottom face of the push-button housing space 1b, to always upward urge the push button 4. The push button 4 is protruded to the side of the upper face of the cover 3 through the push button hole 3a while the upper end of the sliding portion 4a which extends in the lower periphery of the button is pressed by the opening edge portion of the push button hole 3a of the cover 3.

In the thus assembled push-button switch, the case 1, the terminal base 2, and the cover 3 constitute a switch outer case in which the push button 4 is protruded from the upper face, the external connecting terminal portions 10c, 11c, 12c are protruded from the bottom side, and the stationary contacts 10a, 11a, 11b, 12a, 12b are disposed on the side of the inner face to which the movable contacts 9h are opposed.

The feed lever 4c and the rotation star wheel 14 of the rotor 6 constitute a switch driving mechanism which converts the pressing operation of the push button 4 to a rotary motion, and which applies the rotary motion to the movable contacts 9h.

The positioning star wheel 15 of the rotor 6, the indenter 7, and the indenter spring 8 constitute a positioning mechanism which holds the positions of the movable contacts 9h in a state where the push button returns.

Next, the operation of the push-button switch will be described. FIGS. 2, 4, and 5 show the state where the push button returns. In this state, the push button 4 is not depressed, and therefore returns to a free position where the upper end of the sliding portion 4a butts against the cover 3, and the lower end of the pressing piece portion 4f of the feed lever 4c is held at a nonoperating position.

The non-operating position where the lower end of the pressing piece portion 4f of the feed lever 4c is held in the state where the push button returns is a position where, when the lower end of the pressing piece portion 4f is upward moved on a tangent line at a point of a pitch circle of the rotation star wheel 14 where a horizontal line passing the center of the rotation star wheel 14 intersects on the right side of the center, the lower end of the pressing piece portion 4f is separated from the rotation star wheel 14 on the side above the horizontal line passing the center.

A part of the indenter 7 which is protruded toward the bottom of the rotor housing space 1c is fitted into a certain one of the valley portions 15b of the positioning star wheel 15 to restrict free rotation of the rotor 6 and the contact 9, thereby holding the positions of the movable contacts 9h.

At this time, the state of the contact portion of the push-button switch is as shown in, for example, FIG. 10A. Namely, a certain one of three movable contacts 9h is contacted with the common contact 10a, another one of the movable contacts 9h is contacted with the one first selection contact 11a, and the remaining one movable contact 9h is contacted with the fourth insulation contact 13d. Therefore, the common terminal 10 is conductive with the first selection terminal 11, and the second selection terminal 12 is non-conductive, so that the turn-on circuit of the vehicle interior lamp is opened, and the turn-off circuit is closed.

When the push button 4 in the return state is pushed and depressed, the sliding portion 4a and the feed lever 4c are downward moved integrally with the push button 4, and the sliding portion 4a compresses the push-button return spring 5. The lower end of the pressing piece portion 4f of the feed lever 4c butts against the slope of a certain one of the ridge portions 14a of the rotation star wheel 14, and depresses the ridge portion. Therefore, the rotor 6 and the contact 9 are rotated about the rotor shafts if, 6b by a constant angle in the direction a (clockwise direction). In the embodiment, the rotation angle of the rotor 6 and the contact 9 due to the pressing stroke of the push button 4 is 30 deg.

The three movable contacts 9h slide over the movable-contact sliding face 13 while being rotated in conjunction with the rotor 6 and the contact by a rotation angle of 30 deg. about the rotor shafts 1f, 6b in the direction a (clockwise direction). Among the three movable contacts 9h, as shown in FIG. 10B, the certain one movable contact 9h which has been contacted with the common contact 10a is not caused by the rotation angle to pass over the common contact 10a, and hence remains to be contact therewith, the other one movable contact 9h which has been contacted with the one first selection contact 11a is contacted with the first insulation contact 13a which is disposed at the position corresponding to the rotation angle, and the remaining one movable contact 9h which has been contacted with the fourth insulation contact 13d is contacted with the one second selection contact 12a which is disposed at the position corresponding to the rotation angle, thereby switching the contacts. Therefore, the common terminal 10 and the second selection terminal 12 are conductive with each other to make the second selection terminal 12 nonconductive, so that the turn-off circuit of the vehicle interior lamp is opened, and the turn-on circuit is closed.

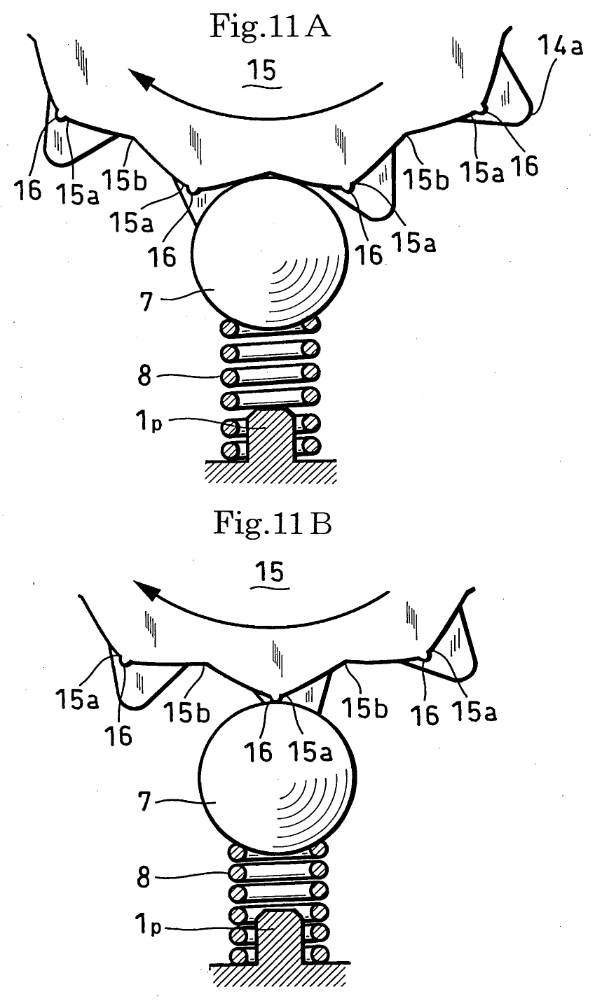

When the contacts are switched as described above, as shown in FIGS. 11A and 11B, the rotor 6 is rotated while the indenter 7 which is pressed by the indenter spring 8 from the immediately below side against the outer periphery of the positioning star wheel 15 is vertically moved between the ridge portions 15a and valley portions 15b that are alternately disposed on the outer periphery of the positioning star wheel 15. The indenter 7 is fitted into the valley portion 15b of the positioning star wheel 15 that is opposed thereto at the rotation angle of 30 deg. of the rotor 6 at which the contacts are switched, and the positions of the rotor 6 and the contact 9 are held to the rotated positions, thereby holding the positions of the movable contacts 9h after the contacts are switched. When the indenter 7 is contacted with the outer periphery of the positioning star wheel 15 on which the ridge portions 15a and the valley portions 15b are alternately disposed, it is possible to produce a sense of operation.

When the pressing of the push button 4 is released, the sliding portion 4a and the feed lever 4c are upward moved integrally with the push button 4 by the push-button return spring 5, to return to the original return state. However, the position of the rotor 6 is fixed by the indenter 7, the indenter spring 8, and the positioning star wheel 15, and the state of the contact is held as it is.

When the push button 4 is again pushed and depressed, the rotor 6 and the contact 9 are rotated about the rotor shafts 1f, 6b by a rotation angle of 30 deg. in the direction a (clockwise direction), and in conjunction with the rotation the three movable contacts 9h are rotated about the rotor shafts if, 6b by the rotation angle of 30 deg. in the direction a (clockwise direction) to be contacted respectively with the contacts corresponding to the rotation angle. In a similar manner as the contact state shown in FIG. 10A, as a result, the common terminal 10 and the first selection terminal 11 are conductive with each other to make the second selection terminal 12 nonconductive, so that the turn-on circuit of the vehicle interior lamp is opened, and the turn-off circuit is closed.

The above-described operations are repeated, and the two kinds of switch circuits are opened/closed by a depression of the push button.

In the push-button switch, the small projection 16 is disposed in the apex of each of the ridge portions 15a of the positioning star wheel 15. When a load of the indenter 7 is applied to the apex of the ridge portion 15a, therefore, the small projection 16 causes a balance to be hardly established, so that, even when the inclination angle of the slope of the ridge portion 15a is not made large, the phenomenon that the positioning star wheel 15 is stopped at a position where the ridge portion 15a is opposed to the indenter 7 can be prevented from occurring. Consequently, it is possible to realize correct and stable switching of the contacts. Since the inclination angle of the slope of the ridge portion 15a is not made large, the effect can be exerted while, as the number of operations of pressing the push button 4 is more increased, the effect is not further lessened to finally disappear. Since the height of the ridge portions 15a can be reduced, moreover, the switch can have a low profile.

Furthermore, the tip end of each small projection 16 is rounded. Therefore, the small projection shows excellent abrasion resistance, so that it is possible to surely prevent the phenomenon that, as the number of operations of pressing the push button 4 is more increased, the above-discussed effect is further lessened, and finally disappears, from occurring.

The above effects can be achieved by the small projection 16 which is very smaller than the ridge and valley portions 15a, 15b and indenter 7 of the positioning star wheel 15. Therefore, a force required for the small projection 16 to override the indenter 7 is negligibly small as compared to that required for the ridge portion 15a to override the indenter 7. The contact switching can be performed by a switch operating force which is equivalent to that in the prior art, and the small projection 16 does not affect the operational sense, so that an operational sense which is equivalent to that in the prior art is obtained.

What is claimed is:

1. A push-button switch wherein said switch includes: a star wheel which is rotated by a constant angular step in one direction by a depression of a push button that automatically returns; an indenter which is pressed against an outer periphery of said star wheel by a spring; a contact which is attached so as to corotate with said star wheel, and which serves as a movable contact; and terminals with which said contact is contacted in accordance with a rotation angle, and which serve as stationary contacts, and a small projection having a rounded tip end is disposed in each of ridge portions of said star wheel.
